(19) United States
(12) Patent Application Publication
(10) Pub. No.: US 2009/0066658 A1
(43) Pub. Date: Mar. 12, 2009

(54) Glove attachment for touch sensitive data entry

(76) Inventor: Steven R. Earl, Clifton, VA (US)

Correspondence Address: LOUIS VENTRE, JR, 2483 OAKTON HILLS DRIVE, OAKTON, VA, 22124-1530, US

(21) Appl. No.: 11/854,164

(22) Filed: Sep. 12, 2007

(51) Int. Cl. G06F 3/041

(52) U.S. Cl. 345/173

(57) ABSTRACT

An attachment to a glove enables electronic data entry on a touchscreen by a person wearing the glove. The attachment is a plate comprising a main body (110) and at least two bendable prongs (120) extending from the main body (110). Each bendable prong has a pointed end (121) capable of being inserted through a finger extremity of a glove and being bent within the glove towards the main body (110) to secure the main body to the finger extremity such that a user's finger in a glove touches a prong. The device further comprises a coating (111) on the plate that is electrically conducting such that a user touching a prong is electrically connected to the main body. The coating has a softness and consistency that tends to minimize scratching an electronic touchscreen upon contact with a touchscreen.

### FIELD OF INVENTION

In the field of electronic data entry using a touchscreen, the invention is a device attachable to a glove to enable electronic data entry by a person wearing the glove.

### BACKGROUND OF THE INVENTION

Touchscreen devices found in popular portable electronics require electrical conductivity from a user's finger to activate the touchscreen. The invention allows the user to maintain electrical conductivity through the fabric of a glove and not scratch the touchscreen electronics.

Touchscreen electronic devices, particularly portable electronic devices such as the APPLE IPHONE and IPOD, should be operable with user input in cold weather conditions and other circumstances where such users are wearing gloves. The most common example is a user commuting from one location to another in a cold weather environment. Another example of very cold environments where the user is likely to be wearing gloves is an aviator using touch-activated high altitude electronics in an emergency situation. Yet another example is users working in cold storage.

One problem is that touchscreen electronic devices commonly require a user to remove a glove to operate the touchscreen. Another problem is that using electrical conductors can scratch a glass touchscreen. The present invention solves these problems and enables a user wearing gloves to activate a touchscreen while minimizing or eliminating the potential for scratching the touchscreen.

### DESCRIPTION OF PRIOR ART

The invention is a device similar to tack or staple with bendable prongs that can be inserted through the fabric at the extremity of a glove finger and thereupon bent in the manner of a staple to secure it to the glove. A soft, protective, electrically-conducting coating on the device, preferably a thermosetting epoxy powder, prevents scratching the surface of a touchscreen while in use. The electrically-conducting coating allows for the conductivity of the user's finger to be transmitted through the fabric and onto the touch screen of the device. The coating also allows the invention to be built in a number of fashionable colors.

Heretofore, the prior art has failed to disclose a device with an electrically-conducting coating which is easily attachable to a variety of gloves or the like and which in use minimizes and/or eliminates damage to touch-sensitive electronics that would otherwise be caused by an electrical conductor attached to a glove.

While the present invention is an attachment to a glove and not a glove, the closest prior art involves gloves having electrical contact attachments that substitute for an electronic game controller. For example, U.S. Pat. No. 5,488,362 discloses a glove-type apparatus for controlling a video game. The glove is lined above and below a wrist portion with parallel conductive contacts as well as on the thumb and fingertips. Placing the hand at an angle selectively connects the contacts, sending the desired direction control signal to the video game. As with other prior art, the '362 patent teaches bringing external contacts on the glove together to create a signal. It does not teach or suggest a direct electrical connection between a user's finger in a glove with coated prongs to enable a touchscreen activation.

Accordingly, the present invention will serve to improve the state of the art of touchscreen electronic devices by providing an inexpensive, easily-installed, easily-removed, electrically-conducting glove attachment that enables a gloved user to activate the touchscreen while minimizing damage from such activation.

### BRIEF SUMMARY OF THE INVENTION

A device is attachable to a glove to enable electronic data entry on a touchscreen by a person wearing the glove. The device is a plate comprising a main body and at least two bendable prongs extending from the main body. Each bendable prong has a pointed end capable of being inserted through a finger extremity of a glove and being bent within the glove towards the main body to secure the main body to the finger extremity such that a user's finger in a glove touches a prong. The device further comprises a coating on the plate that is electrically conducting such that a user touching a prong is electrically connected to the main body. The coating has a softness and consistency that tends to minimize scratching an electronic touchscreen upon contact with a touchscreen.

### BRIEF DESCRIPTION OF THE DRAWINGS

Referring now to the drawings in which like reference numbers represent corresponding parts throughout:

FIG. 1 is a perspective of a preferred embodiment of the device having two bendable prongs positioned to facilitate shipping.

FIG. 2 is a perspective of a preferred embodiment of the device having two bendable prongs positioned for insertion in a glove.

### DETAILED DESCRIPTION

In the following description, reference is made to the accompanying drawings, which form a part hereof and which illustrate several embodiments of the present invention. The drawings and the preferred embodiments of the invention are presented with the understanding that the present invention is susceptible of embodiments in many different forms and, therefore, other embodiments may be utilized and structural and operational changes may be made without departing from the scope of the present invention.

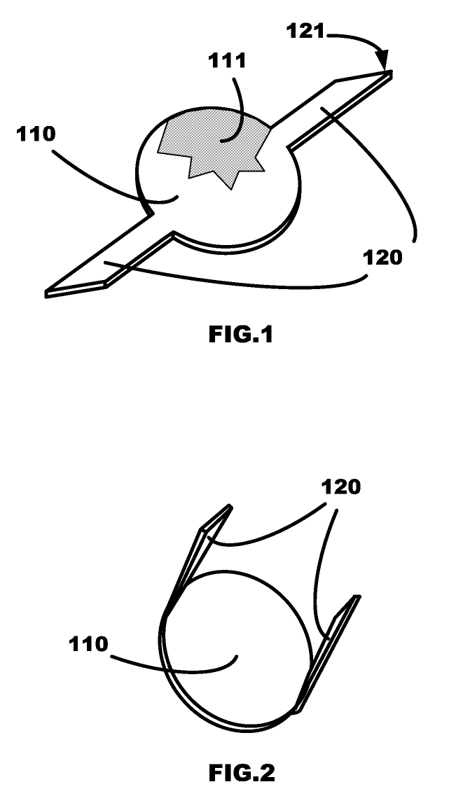

FIG. 1 shows a perspective of a preferred embodiment of the device having a plate with a generally circular main body (110) and two bendable prongs (120) positioned such that the plate is flat. In this embodiment, the plate has a thickness in a range of about 0.4 to 0.5 millimeters; the main body has a diameter in a range of about 8 to 10 millimeters; and each bendable prong has a length in a range of about 5 to 7 millimeters measured from the main body and a width of about 1 to 2 millimeters.

The bendable prongs (120) extend from the main body (110). Each prong has a pointed end (121) capable of being inserted through a finger extremity of a glove and being bent within the glove towards the main body (110) to secure the main body (110) to the glove's finger extremity such that a user's finger in a glove touches a prong.

FIG. 2 shows a perspective of the flat plate with the bendable prongs (120) configured or bent to a position about 90 degrees from the flat position, that is approximately perpendicular to the plane of the main body (110). This configuration is considered preferred immediately prior to inserting the prongs through a finger extremity of a glove.

A coating (111), preferably over the entire plate, is shown as a cross-hatched area over a portion of the plate to aid in its illustration. The extent of coverage of the coating (111) over the plate is important only to the extent that it serves to electrically connect a user touching a prong (120) to the main body (110). The device is intended to enable the creation of an electrical connection between human skin on a finger of a user wearing the glove and touch sensitive electronics exterior to the glove.

The coating (111) has a softness and consistency that tends to minimize scratching an electronic touchscreen upon contact with a touchscreen. Generally, this means that the coating must be of a material that is softer than a glass touchscreen. The preferred coating (111) meeting these requirements is a thermosetting epoxy powder, such as a combination epoxy, polyester and vinyl. Other candidate coating materials include TEFLON, resin, polymer or mixtures thereof.

The term “plate” as used herein is intended to be broadly construed to include any shape main body having or configured with bendable prongs, such as a main body (110) having a square, rectangle, circular, oval, star, diamond or other cross-sectional shape. The main body may be contoured to the shape of a glove finger extremity or it may be simply flat. The physical shape of the plate configured with bendable prongs is immaterial to the function of the plate. The flat plate configuration in FIG. 1 is a preferred embodiment for manufacturing, packaging and shipping the device. The prongs (120) may be separate components from the main body, but are preferably formed as a single unit with the main body (110) constituting the plate.

The plate may be made with any pliable material. Preferable materials are pliable metals, such as aluminum or nickel. Non-metallic materials, such as bendable plastic, may also be used.

The above-described embodiments including the drawings are examples of the invention and merely provide illustrations of the invention. Other embodiments will be obvious to those skilled in the art. Thus, the scope of the invention is determined by the appended claims and their legal equivalents rather than by the examples given.

What is claimed is:

1. A device attachable to a glove to enable electronic data entry on a touchscreen by a user wearing the glove comprising,
(a) a plate comprising a main body and a plurality of bendable prongs extending from the main body, wherein each of said prongs has a pointed end capable of being inserted through a finger extremity of a glove and being bent within the glove towards the main body to secure the main body to said finger extremity such that a user's finger in a glove touches a prong; and,
(b) a coating on the plate that is electrically conducting such that a user touching a prong is electrically connected to the main body, and wherein the coating has a softness and consistency that tends to minimize scratching an electronic touchscreen upon contact with a touchscreen.

2. The device of claim 1 wherein the coating is made of a material selected from a group consisting of a thermosetting epoxy powder, TEFLON, resin, and polymer.

3. The device of claim 1 wherein the plate has a thickness in a range of about 0.4 to 0.5 millimeters; the main body has a diameter in a range of about 8 to 10 millimeters; and each bendable prong has a length in a range of about 5 to 7 millimeters measured from the main body and a width of about 1 to 2 millimeters.
